(19) United States
(12) Patent Application Publication
(10) Pub. No.: US 2018/0004044 A1
(43) Pub. Date: Jan. 4, 2018

(54) ELECTRODELESS ORGANIC LIGHT-EMITTING DEVICE AND LCD SYSTEMS USING SAME

(71) Applicant: Corning Incorporated, Corning, NY (US)

(72) Inventors: Daniel Aloysius Nolan, Corning, NY (US); Mark Alejandro Quesada, Horseheads, NY (US); Wageesha Senaratne, Horseheads, NY (US)

(21) Appl. No.: 15/541,151

(22) PCT Filed: Jan. 6, 2016
(86) PCT No.: PCT/US16/12253

§ 371 Date: Jun. 30, 2017

Related U.S. Application Data
(60) Provisional application No. 62/100,288, filed on Jan. 6, 2015.

(51) Int. Cl. G02F 1/1335; F21V 8/00

(52) U.S. Cl. CPC G02F 1/133621; G02B 6/0081; G02B 6/005; G02F 2001/133614

(57) ABSTRACT

An electrodeless organic light-emitting device (10) and LCD systems using same are disclosed. The electrodeless organic light-emitting device (10) includes an organic light-emitting structure (200) with at least one organic light-emitting layer (250), and an illuminator (100) operably disposed to illuminate the organic light-emitting structure (200) with redirected light (114D). The redirected light (114D) causes the one or more organic light-emitting layers (250) to emit light (254), which constitutes the illumination from the organic light-emitting device (10). An LCD system includes the electrodeless organic light-emitting device (10) operably arranged relative to an LCD panel to receive the illumination (254). The organic light-emitting layer (250) can be segmented, with each segment emitting a primary color of light. The organic light-emitting layer segments are aligned with the cells of the LCD panel to define pixels for forming a display image. The LCD system can be configured to have a non-black background color when in the “off” state. Methods of forming illumination and display light are also disclosed.

This application claims the benefit of priority under 35 U.S.C. §119 of U.S. Provisional Application Ser. No. 62/100,288 filed on Jan. 6, 2015 the content of which is relied upon and incorporated herein by reference in its entirety.

### FIELD

The present disclosure relates to organic light-emitting devices (OLEDs), and in particular relates to an electrode-less OLED luminaire, and to liquid-crystal display (LCD) systems using same.

### BACKGROUND

An OLED is a type of light-emitting device that relies on electroluminescence of an organic material (film) when subjected to an electric current from transparent electrodes arranged on each side of the organic material. Because of their excellent light-emitting properties, OLEDs are attractive as light sources for a variety of display applications.

Certain types of displays, such as LCDs, use light sources or “backlights” as the display light source. In an LCD, electrically addressable liquid-crystal-based pixels made up of red, green and blue sub-pixels are used to emit different amounts of their respective colors by changing the polarization of the liquid crystal material in each sub-pixel.

OLEDs can be used to form a luminaire for a display such an LCD because they can emit light over a broad range of colors in the visible spectrum, e.g., can generate “white” light. However, there are a number of technical problems with OLEDs that make the fabrication of a commercially viable OLED luminaire problematic. One technical problem is that up to 80% of the light emitted by an OLED remains trapped in the organic layer. Extraction methods have been developed to improve the light-emission efficiency of OLEDs, but the extraction needs to occur quickly or the cathode in the OLED structure will absorb the light in plasmon modes.

Another problem is the complicated OLED structure. The OLED structure is made up of a number of stacked layers that need to be deposited so that the electrodes can efficiently cause light emission from the organic layer. As many as seven and even ten layers need to be finely deposited. Another problem is the need for the aforementioned conductive electrodes. The anode and the cathode are typically deposited as layers of conductive material. The anode, through which the light is usually emitted, is typically made of a transparent conducting oxide (TCO) layer, such as a indium tin oxide or ITO, and is on the order of 150 nm thick. Another problem is the lifetime of the OLED materials, which is limited in part due to the inefficient light-emission process, which necessitates higher electrode excitation. All of these problems lead to a prohibitively expensive and inefficient OLED-based luminaire with a limited lifetime.

### SUMMARY

Aspects of the disclosure are directed to a OLED luminaire that does not employ electrodes for electrical excitation of the organic layer(s) and instead employs optical excitation of the organic layer(s). Electrically excited OLEDs are very sensitive to thickness variations in the organic layers. This is because large voltages are imposed across these layers and any variation in thickness reduces the resistance in the thinner sections. This increases the current in the thinner sections relative to the thicker sections, causing the thinner sections to burn out faster.

The optical excitation of the OLED layer(s) is enabled by an illuminator that has a light-redirecting member, such as a transparent glass panel, that is configured to redirect light from a light source into the OLED structure. This redirected light is absorbed by the OLED molecules, which then emit light via fluorescence. By selecting the OLED material, select wavelengths of the emitted light can be generated. When the select wavelengths include primary colors, the illumination can be configured to generate colored light within a color gamut, including white light. A white diffusive coating included in the OLED structure can be used to reflect redirected light and the emitted OLED light. An optional extraction layer can be employed in the OLED structure, but in some embodiments is not used so that the OLED layer can be arranged as close as possible to an LCD panel to form an LCD system.

Other aspects of the disclosure are directed to an electrodeless OLED luminaire that includes an OLED structure with one or more OLED layers, and an illuminator operably disposed to illuminate the OLED structure with redirected light. The redirected light causes the one or more OLED layers to emit light that constitutes the illumination. An LCD system includes the electrodeless OLED luminaire operably arranged relative to an LCD panel. The OLED layer can be segmented, with each segment emitting a primary color of light. The OLED segments, which in an example can be considered as sub-pixels, are aligned with the cells of the LCD panel to define pixels for forming a display image. The LCD system can be configured to have a non-black background color when in the “off” or “background” state.

An aspect of the disclosure is a luminaire apparatus that emits illumination and that includes: an illuminator having at least one light source that generates first light having a first wavelength, the light source being operably coupled to a light-redirecting member, which receives the first light and forms therefrom redirected light; an organic light-emitting device (OLED) structure operably arranged adjacent the light-redirecting member, the OLED structure having at least one organic layer that emits light when irradiated by the redirected light, wherein the OLED structure does not include any conductive electrodes; and wherein the emitted light from the OLED structure constitutes the illumination.

Another aspect of the disclosure is the luminaire apparatus described above, wherein the light-redirecting member includes a planar sheet that is substantially transparent to the first light and that includes at least one type of light-redirecting feature.

Another aspect of the disclosure is the luminaire apparatus described above, wherein the at least one type of light-redirecting feature is selected from the group of light-redirecting features comprising: a light-redirecting layer, a surface roughness, internal voids, internal particles and internal refractive index variations.

Another aspect of the disclosure is the luminaire apparatus described above, wherein the first wavelength has a blue or a violet wavelength.

Another aspect of the disclosure is the luminaire apparatus described above, wherein the at least one organic layer includes multiple organic layers, with each organic layer emitting a different wavelength of light when irradiated by the redirected light.

Another aspect of the disclosure is the luminaire apparatus described above, wherein the multiple organic layers each emit either: i) one of red and green light or ii) one of red, green and blue light.

Another aspect of the disclosure is the luminaire apparatus described above, wherein the OLED structure including a sealing structure operably disposed around at least the at least one organic layer.

Another aspect of the disclosure is display system that includes the luminaire apparatus as described above, and a LCD panel operably arranged adjacent the luminaire apparatus to receive the illumination from the luminaire.

Another aspect of the disclosure is the display system described above, wherein the display system has a background state that provides one of a white background, a colored background and a translucent background.

Another aspect of the disclosure is the luminaire apparatus described above, wherein OLED structure includes opposite front and back surfaces, wherein the light-directing member is operably arranged adjacent the front surface of the OLED structure, and wherein the illumination light travels through the front surface of the OLED structure and then through the light-redirecting member.

Another aspect of the disclosure is the luminaire apparatus described above, wherein the OLED structure includes a light-redirecting layer arranged adjacent the at least one organic layer on a side opposite the light-redirecting member so that the light-redirecting member and the light-redirecting layer sandwich the at least one organic layer.

Another aspect of the disclosure is the luminaire apparatus described above, wherein the at least one OLED layer generates light that remains trapped therewithin, and wherein the light-redirecting layer has a rough surface arranged in intimate contact with the at least one organic layer, the rough surface having an amount of surface roughness that facilitates the extraction of trapped light from the at least one organic layer.

Another aspect of the disclosure is the luminaire apparatus described above, wherein the amount of surface roughness of the rough surface of the light-redirecting layer is greater than 50 nm root-mean-square (RMS) and has a periodicity of less than 2 microns.

Another aspect of the disclosure is the luminaire apparatus described above, wherein OLED structure includes opposite front and back sides, wherein the light-directing member is operably arranged adjacent the back side of the OLED structure, and wherein the redirected light travels through the back side of the OLED structure and the illumination is emitted from the OLED structure through the front side of the OLED structure.

Another aspect of the disclosure is the luminaire apparatus described above, further including a diffuse reflective layer on a side of the light-redirecting member opposite the OLED structure.

Another aspect of the disclosure is a display system that includes the luminaire apparatus as described above, and an LCD panel operably arranged adjacent the luminaire apparatus to receive the illumination from the luminaire.

Another aspect of the disclosure is the display system described above, wherein the LCD panel includes an array of cells configured to control the transmission of light therethrough, and wherein the at least one organic layer includes a segmented organic layer having an array of segments, with each segment being aligned with a corresponding cell of the LCD panel.

Another aspect of the disclosure is the display system described above, wherein each segment emits light having a primary-color wavelength.

Another aspect of the disclosure is the display system described above, wherein the redirected light is blue, wherein each segments emits one of red and green primary-color light, and wherein the segmented organic layer includes open portions that are aligned with corresponding cells of the LCD panel and that pass the blue redirected light.

Another aspect of the disclosure is the display system described above, wherein the display system has a viewer side, and wherein the LCD panel resides on the viewer-side of the segmented organic layer.

Another aspect of the disclosure is the display system described above, wherein the display system has a viewer side, and wherein the segmented organic layer resides on the viewer side of the LCD panel.

Another aspect of the disclosure is the display system described above, wherein the display system is encompassed by a sealing structure.

Another aspect of the disclosure is a method of forming illumination, wherein the method includes: providing an OLED structure having front and back surfaces and at least one organic layer that emits light when irradiated with light of a first wavelength, wherein the OLED structure does not include any conductive electrodes; and generating first light of the first wavelength and redirecting the first light to irradiate the at least one organic layer through either the front or back surface of the OLED structure to cause the at least one organic layer to emit light from the front surface of the OLED structure, wherein the emitted light constitutes the illumination.

Another aspect of the disclosure is the method described above, wherein redirecting the first light includes sending the first light through a light-redirecting member that includes at least one type of light-redirecting feature.

Another aspect of the disclosure is the method described above, including encompassing at least a portion of the OLED structure with a sealing structure.

Another aspect of the disclosure is the method described above, further including directing the illumination though an LCD panel to form display light.

Another aspect of the disclosure is the method described above, wherein the illumination includes red, green and blue light, and wherein the LCD panel is configured to transmit the display light over a color gamut defined by the red, green and blue illumination.

Another aspect of the disclosure is the method described above, wherein the display light is provided in a background state as white light or colored light.

Another aspect of the disclosure is the method described above, including terminating the irradiation of the at least one organic layer and configuring the LCD panel to be substantially translucent.

Another aspect of the disclosure is the method described above, wherein the OLED layer includes segments, with each segment emitting light have one wavelength of two or three primary-color wavelengths when irradiated by the redirected light, and wherein the emitted light from each segment passes through at least one cell of an LCD panel arranged adjacent the OLED structure.

Another aspect of the disclosure is the method described above, wherein each segment emits either red or green light, wherein the OLED layer includes openings through which the illumination light can pass through, and wherein the illumination is blue light.

Another aspect of the disclosure is the method described above, wherein the OLED layer includes segments, with each segment emitting light have one wavelength of two or three primary-color wavelengths when irradiated by the redirected light, and wherein the illumination passes through at least one cell of an LCD panel and then irradiates at least one segment of the OLED layer.

Another aspect of the disclosure is the method described above, wherein each segment emits either red or green light, wherein the OLED layer includes openings through which the illumination light can pass through, and wherein the illumination is blue light.

### BRIEF DESCRIPTION OF THE DRAWINGS

The following detailed description of specific embodiments of the present disclosure can be best understood when read in conjunction with the following drawings, where like structure is indicated with like reference numerals. Cartesian coordinates are include in some of the Figures for the sake of reference and ease of discussion, and are not intended to be limiting as to direction or orientation.

FIG. 1 is a side view of an example electrodeless OLED luminaire according to the disclosure;

FIG. 2 is a partially explode view of the electrodeless OLED luminaire of FIG. 1;

FIGS. 3A and 3B are front-side views of examples of the light-redirecting member of the illuminator of the electrodeless OLED luminaire;

FIGS. 4A through 4C are close-up views of an example light source optically coupled to the bottom edge of light-redirecting member;

FIG. 5A is a close-up cross-sectional view of a light-redirecting member having a light-redirecting layer on its front surface;

FIG. 5B is similar to FIG. 5A and illustrates an example wherein the light-redirecting member has an amount of surface roughness;

FIG. 5C is similar to FIG. 5B and illustrates three different types of light-redirecting features within the body of the light-redirecting member;

FIG. 6 is a partially exploded side view of electrodeless OLED structure wherein the OLED material layer includes three organic layers that respectively emit different colors of light;

FIGS. 7A and 7B are cross-sectional views of an example electrodeless OLED luminaire that illustrate the general operation of the OLED luminaire;

FIG. 8A is an exploded side view of an example LCD system the utilizes the electrodeless OLED luminaire disclosed herein as a backlight;

FIG. 8B is a partially exploded side view of the LCD system of FIG. 8A that illustrates the diverging nature of the illumination and the display light;

FIG. 9A is a side view of an example of the electrodeless OLED luminaire wherein the light-redirecting member is disposed behind the OLED structure;

FIG. 9B is a partially exploded view of the example electrodeless OLED luminaire of FIG. 9A;

FIG. 10A is an exploded side view and FIG. 10B is an unexploded side view of an example LCD system that utilizes the electrodeless OLED luminaire of FIGS. 9A and 9B as a backlight;

FIG. 11 is an exploded side view of the example LCD system of FIGS. 9A and 9B showing the cell structure of the LCD panel and a segmented structure of the OLED layer;

FIG. 12 is a front-on view of an example organic layer wherein the segmented configuration is defined by groups sub-pixels that define pixels;

FIG. 13 is a cross-sectional view of the LCD system of FIG. 11 that shows the sub-pixels (segments) of the organic layer of OLED structure aligned with the cells of the LCD panel and also shows how the light from the illuminator is processed to form the display light;

FIG. 14 is a close-up cross-sectional view of the LCD system of FIG. 11 that shows an example of how the light emitted from the segments or sub-pixels of the organic layer pass through the substrate and then through the corresponding (aligned) cells of the LCD panel;

FIG. 15A is an exploded side view and FIG. 15B is an unexploded side view of an example LCD system similar to that of FIG. 10 but wherein the organic structure is on the front or viewer side of the LCD system;

FIG. 16A is similar to FIG. 13 and shows the sub-pixels (segments) of the organic layer of OLED structure aligned with the cells of the LCD panel and also shows how the light from the illuminator is processed to form the display light; and

FIG. 16B is similar to FIG. 16A but includes blue-emitting segments of the organic layer rather than open portions;

### DETAILED DESCRIPTION

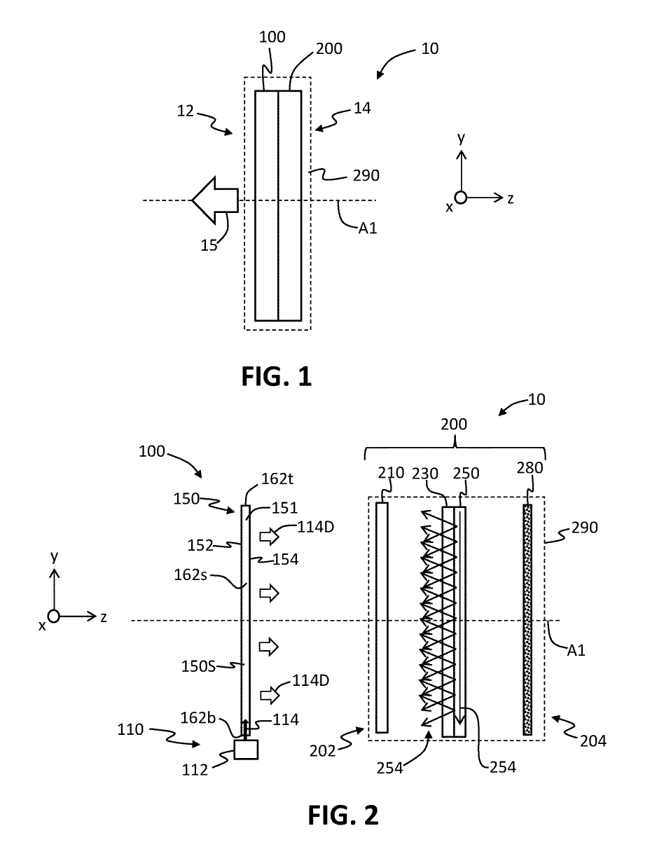

FIG. 1 is a side view and FIG. 2 is an exploded side view of an example electrodeless OLED luminaire apparatus (“OLED luminaire) 10 according to the disclosure. The OLED luminaire 10 includes a front side 12 and a back side 14, with OLED illumination (“illumination”) 15 being emitted from the front side. The OLED luminaire 10 has an illumination system (“illuminator”) 100 operably arranged relative to an electrodeless OLED structure 200. The illuminator 100 includes a light source system 110 having one or more light sources 112 optically coupled to a light-redirecting member 150. In an example, multiple light sources 112 are arranged in one or more arrays relative to light-redirecting member 150, as described below.

The light sources 112 each emit light 114. In the discussion below “light” 114 is also referred to as “light beam” 114. In one example, illuminator 100 includes multiple light sources 112 that all emit light 114 of substantially the same wavelength. In another example, illuminator 100 includes multiple light sources 112, wherein each light source emits light 114 having a single wavelength selected from two or more different wavelengths. In an example, the one or more light sources 112 are lasers, and further in an example are laser diodes. In an example, the one or more light sources 112 can include one or more blue laser diodes or one or more ultraviolet laser diodes. In an example where multiple light sources 112 are used, each light source can be one type of laser diode selected from two or more different types of laser diodes that respectively emit two or more different wavelengths of light 114.

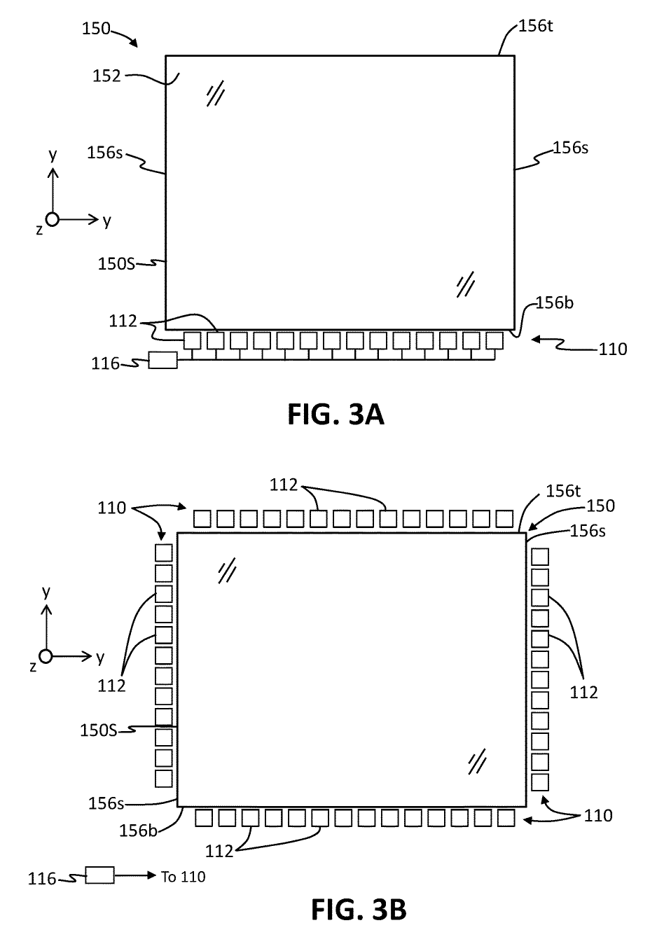

FIGS. 3A and 3B are front-side views of examples of light-redirecting member 150. With reference to FIG. 2 and FIGS. 3A and 3B, in an example, light-redirecting member 150 comprises a generally transparent sheet 150S having a body 151, a front side (front surface) 152, a back side (back surface) 154, a top edge 156t, a bottom edge 156b, and side edges 156s. In an example, the transparent sheet 150S is substantially transparent to visible wavelengths of light as well as to ultraviolet wavelengths of light, as explained below. In an example, transparent sheet 150S is made of a low-alkaline glass, which is substantially transparent to UV light as low as 350 nm. In another example, the transparent sheet 150S is made of either fused silica or calcium fluoride, with these materials having good optical transmission down to about 190 nm.

FIG. 3A shows an example light source system 110 wherein the light sources 112 are arranged along the bottom edge 156b of light-redirecting member 150. In an example, light sources 112 are electrically connected to a controller 116 (e.g., a microcontroller) that controls the activation of each light source. FIG. 3B shows an example light source system 110 wherein light sources 112 are arranged along the bottom edge 56b, the top edge 56t and the side edges 56s. In an example, light source system 110 is configured with light sources 112 operably arranged adjacent at least one of the bottom edge 156b, the top edge 156t and the side edges 156s.

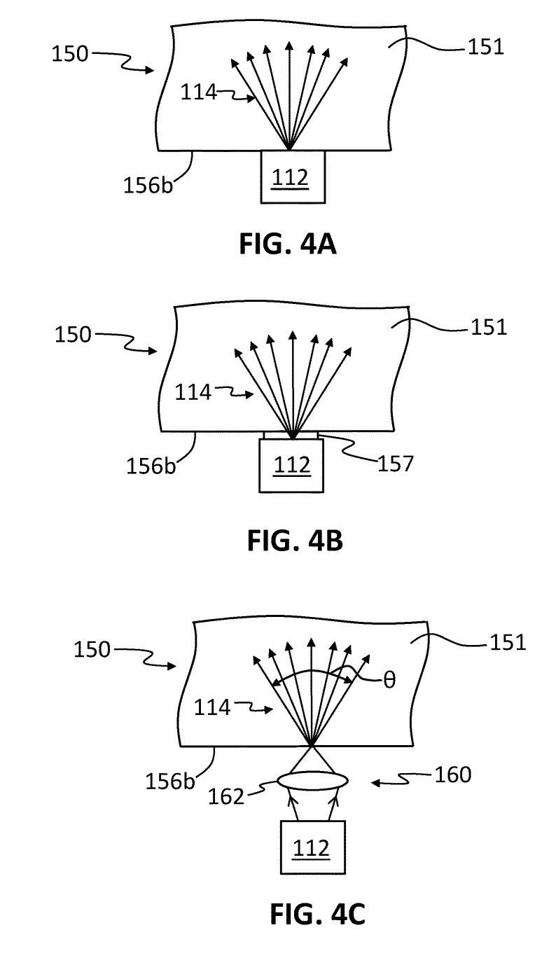

FIGS. 4A through 4B are close-up views of an example light source 112 optically coupled to the bottom edge 156b of light-redirecting member 150 and emitting light beam 114 into the body 151 of the light-redirecting member. In an example, light beam 114 is divergent. In FIG. 4A, light source 112 is edge coupled to the bottom edge 156b of light-redirecting member 150. FIG. 4B is the same as FIG. 4A and additionally includes an index-matching material (e.g., an index-matching fluid) operably disposed between light source 112 and bottom edge 156b to facilitate the efficient edge coupling of light 114 into body 151 of light-redirecting member 150. FIG. 4C is similar to FIGS. 4A and 4B, except that an optical system 160 is operably disposed between the bottom edge 156b of the light-redirecting member and light source 112 to facilitate coupling of light 114 into body 151. In an example, optical system 160 includes one or more optical elements 162 configured to define a beam divergence angle θ of light beam 114 within body 151 of light-redirecting member 150. In an example, the beam divergence angle θ is such that light beam 114 is generally trapped within body 151 by total internal reflecting at front and back surfaces 152 and 154.

The light-redirecting member 150 is configured to redirect at least a portion of light 114 traveling within body 151 out of back surface 154 as redirected or “deflected” light 114D. In an example, light-redirecting member 150 includes one or more different types of light redirecting features.

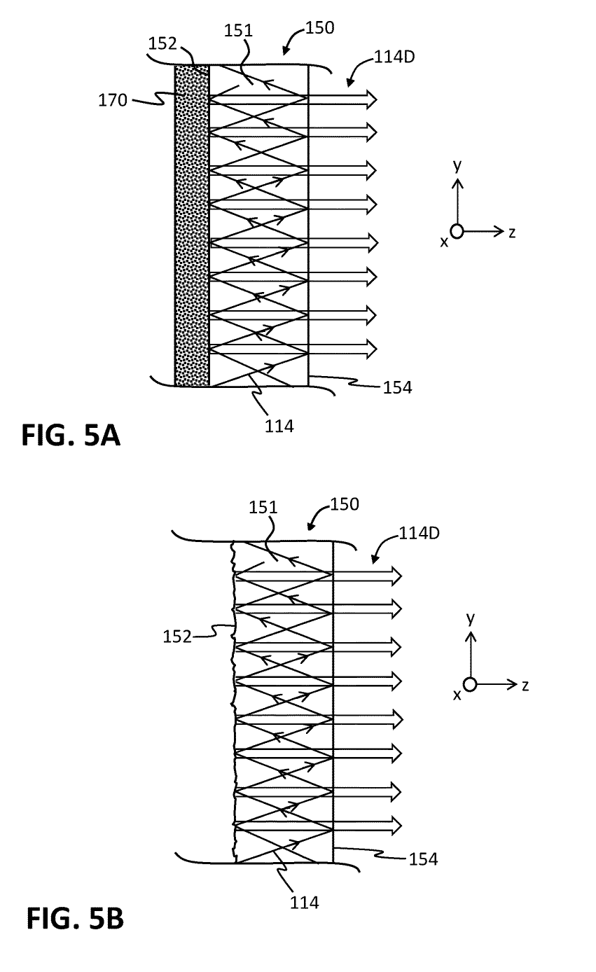

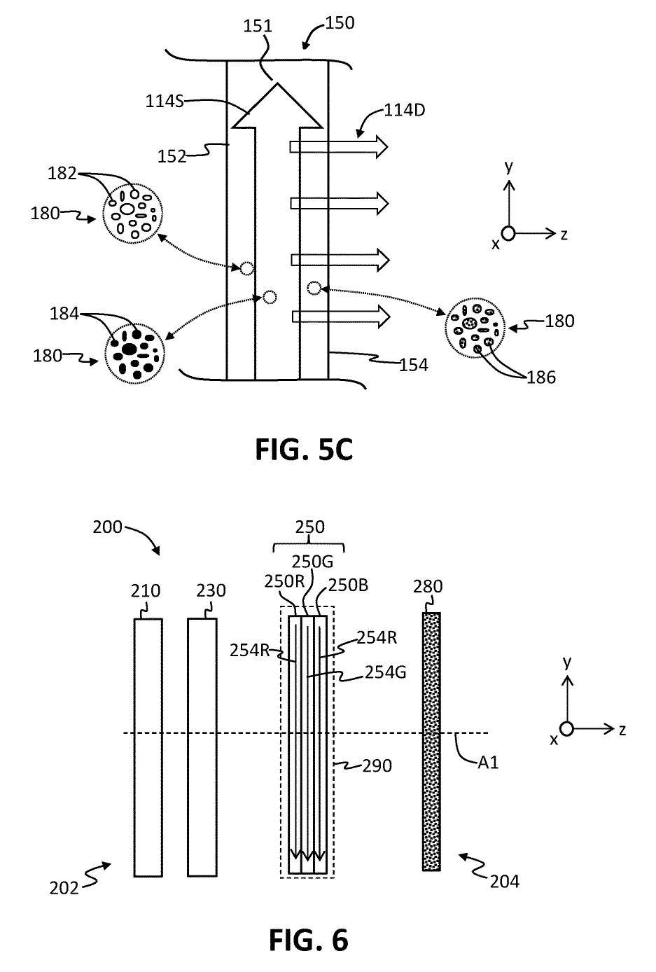

FIG. 5A is a close-up cross-sectional view of light-redirecting member 150 that illustrates an example wherein body 151 of the light-redirecting member is generally transparent and has a relatively low attenuation at the wavelength of light 114, and wherein front surface 152 includes a light-redirecting layer 170 as the light-redirecting feature. In an example, light-redirecting layer 170 is configured to scatter or diffuse light 114 that would otherwise totally internally reflect from front surface 152, thereby forming redirected light 114D that exits back surface 154. The redirected light 114D travels towards OLED structure 200, which is discussed below. An example light-redirecting layer 170 includes light-scattering particles, such as zirconia nanoparticles.

FIG. 5B is similar to FIG. 5A and illustrates an example light-redirecting member wherein front surface 152 is a rough surface defined by an amount of surface roughness a (e.g., RMS surface roughness) that causes light 114 to scatter therefrom to form redirected light 114D that exits the back surface 154. In an example, the surface roughness a is in the range from 50 nm to 250 nm. Thus, in an example, the light-redirecting feature of light-redirecting member 150 comprises a rough surface (e.g., a rough front surface 152) of light-redirecting member 150.

FIG. 5C is similar to FIG. 5B and illustrates an example embodiment wherein body 151 of light-redirecting member 150 includes one or more types of internal light-redirecting features 180 that cause a portion of light 114 to be redirected out of the back 154 of the light-redirecting member as redirected light. In an example, the internal light-redirecting features 180 comprise light-scattering or light-diffusing elements or structures, such as voids 182, particles 184, or refractive-index variations 186, as respectively illustrated in the three close-up insets of FIG. 5C. The light-redirecting features 180 within body 151 need not all be of the same type. In an example, internal light-redirecting features 180 are randomly arranged, while in another example they can be quasi-randomly arranged, e.g., their distribution can be defined by a periodic component and a random component. In FIGS. 5A through 5C, the redirected light 114D is represented by arrows for ease of illustration. In practice, the re-directed light is not generally collimated and exits back surface 154 over a relatively wide range of angles.

With reference again to FIG. 2, OLED structure 200 has a front surface 202 and a back surface 204, and in an example includes in order from the front surface to the back surface: a transparent substrate 210, an optional extraction layer 230, at least one light-emitting organic material layer (“organic layer”) 250, and a light-redirecting layer 280. The transparent substrate 210 can be made of glass. The organic layer 250 is made up of organic material, such as Alq3, that emits light 254 when irradiated by redirected light 114. The extraction layer 230 is configured to enhance the extraction of light 254 generated in the organic layer 250 and that would otherwise remain confined within the organic layer. Example configurations for extraction layer 230 are disclosed in U.S. Pat. No. 8,538,224, U.S. Patent Publication No. 2009/0015142 and U.S. Provisional Patent Application Ser. No. 62/068,190. The light generated by and emitted from OLED 250 is denoted 254. In the example configuration of OLED luminaire 10 of FIG. 2, the light-redirecting member 110 and the light-redirecting layer 280 sandwich the organic layer 250, with the light-redirecting layer residing in intimate contact with back side of the organic layer.

In an example, at least a portion of the OLED luminaire 10 that includes the OLED structure 250 is encompassed by a sealing structure 290, such as shown in FIG. 1 and in FIGS. 6, 7A, 8A, 9A and 10B and 15B. The sealing structure 290 configured to form a hermetic seal and to reduce detrimental environmental effects, such as photo-oxidation, photo-bleaching and rapid fading, that can substantially impact the performance of the OLED structure. In the example illustrated in FIG. 2, sealing structure 290 is shown as encompassing transparent substrate 210, extraction layer 230, organic layer 250, and a light-redirecting layer 280. In another example illustrated in FIG. 6 (introduced and discussed immediately below), sealing structure 290 encompasses organic layer 250. The sealing structure 290 can be any type of sealing structure known in the art. Example types of sealing structures 290 can include frit seals, sputter-based encapsulating structures and laser-welded structures. Example materials for sealing structure 290 include metal, glass and plastic. In an example, sealing structure 290 can contain materials, such as a getter material, that reduce the rate of degradation due to environmental effects.

FIG. 6 is a partially exploded side view of electrodeless OLED structure 200 that illustrates an example wherein the OLED layer 250 includes three organic layers 250R, 250G and 250G that respectively emit red, blue and green light 254R, 254G and 254B when irradiated by redirected light 114. In an example, the organic layers 250R, 250G and 250B include the different formulations of the aforementioned material Alq3, wherein each layer is configured with absorption and emission properties to generate (emit) the red, blue and green light 254R, 254G and 254B when irradiated by redirected light 114D. In an example, redirected light 114D has an ultraviolet wavelength, such as 350 nm, that serves to cause the generation and emission of red, blue and green light 254R, 254G and 224B from the respective organic layers 250R, 250G and 250B. In another example, redirected light 114 includes three different wavelengths, with each wavelength selected to correspond to the optimum or near-optimum absorption wavelength of one of the organic layers 250R, 250G and 250B.

An important feature of electrodeless OLED structure 200 is that it does not include either a cathode layer or an anode layer, i.e., the electrodeless OLED structure has no electrical connections, which are referred to in the art as electrodes. This is because OLED structure 200 is optically activated by the redirected light 114D from illuminator 100 and so does not require conductive elements to activate the at least one organic layer 250 to cause the emission of light 254.

In an example, light-redirecting layer 280 comprises a white scattering material (e.g., white paint or the like) that scatters light in the visible wavelength range in substantially equal amounts. In an example, the white scattering material can be rough (i.e., can have an amount of surface roughness) to enhance extraction of the colored light 254 generated by the OLED layer 250 but that remains trapped within the OLED layer. Since there are no metal electrodes employed, the possibility of generating detrimental surface plasmon polaritons due to a rough conducting surface is obviated. The roughness can be even greater than 50 nm RMS, with periodicities of less than 2 microns to enhance extraction. These relatively large amounts of surface roughness are permitted since because there are no high electrode voltages that would otherwise cause shorting, which adversely affects lifetime.

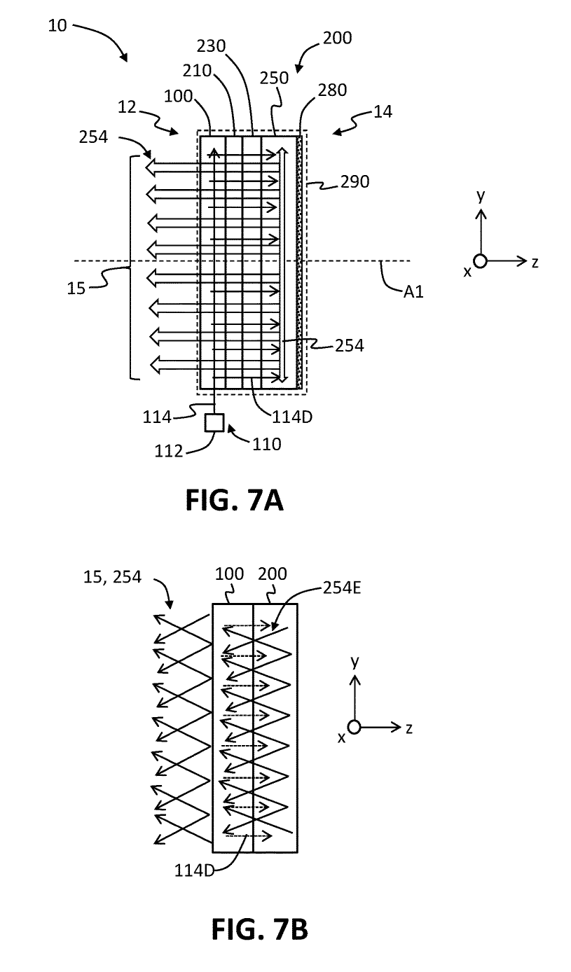

FIG. 7A is cross-sectional view of an example OLED luminaire 10 that illustrates the general operation of the OLED luminaire. The light 114 is emitted by light source 112 of light source system 110 and into light-redirecting member 150 in the y-direction. The light 114 is redirected by light-redirecting member 150 to form redirected light 114D that in the example shown travels generally in the x-direction through glass substrate 210, through extraction layer 230 and into organic layer 250. An example of sealing structure 290 is also shown as part of OLED luminaire 10.

As noted above, redirected light 114D has at least one wavelength that causes the organic layer 250 to generate (emit) light 254. In an example, light 254 includes one or more wavelengths, and further in an example can include sufficient amounts of red, green and blue light 254R, 254G and 254B so that light 254 can constitutes “white” light. In practice, the redirected light 114D travels over a relatively large range of angles, but this does not adversely affect the emission of light 254 within organic layer 250, which light emission occurs over a wide range of angles, e.g., substantially uniformly in all directions. However, most of the light 254 generated in by the organic layer ends up being trapped within the organic layer. The use of extraction layer 230 increases the amount of emitted light 254 that actually leaves organic layer 250.

A portion of redirected light 114D that is not absorbed by the organic material in organic layer 250 travels therethrough and is incident upon the light-redirecting layer 280, which directs some of the redirected light back into the organic layer, thereby increasing the light emission from the organic layer. Some of the light 254 generated by the organic layer is also emitted and is incident upon and redirected by the light-redirecting layer 280, which causes a portion of this emitted light to be redirected to travels back through the organic layer 250. In the meantime, the optional extraction layer 230 acts to enhance the amount of emitted light 254 that travels in the −x direction back toward light-redirecting member 250. In another example, light-redirecting layer 280 serves as the light-extraction layer in the manner described above, thereby obviating the need for light-extraction layer 230.

The emitted light 254 from OLED structure 200 travels through light-redirecting member 250 and defines illumination 15. The emitted light 254 will typically experience some redirection when it passes through light-redirecting member 150. This redirection does not substantially detract from the quality of the OLED illumination 15 since the emitted light 254 travels over a relatively wide range of angles to begin with, and the OLED illumination 15 also travels over a relatively wide range of angles, as illustrated in FIG. 7B.

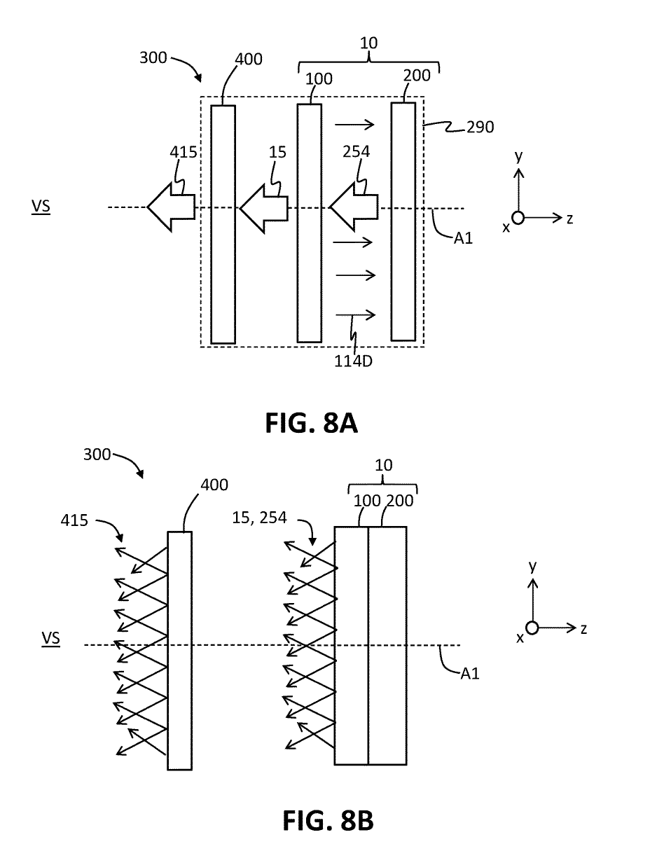

FIG. 8A is an exploded side view of an example LCD system 300 that has a viewer side VS from which the LCD system is viewed. The LCD system 300 includes OLED luminaire 10 operably arranged relative to an LCD panel 400 to serve as a backlight. An example sealing structure 290 is shown that encompasses the entire LCD system 300.

FIG. 8B is a partially exploded view of the LCD system 300 of FIG. 8A. As described above, illuminator 100 generates redirected light 114D that in the example shown travels in the −z direction to OLED structure 200. In response, OLED structure 200 generates emitted light 254 as discussed above. The emitted light 254 travels generally in the +z direction through the light-redirecting member 150 to form redirected emitted light 254, which constitutes illumination 15. The OLED illumination 15 thus serves to back-illuminate LCD panel 400. The LCD panel 400 includes an array of light-controlling switches or cells as discussed below, and operates in the manner known in the art to modulate illumination 15 to generate display light 415, which in an example defines a display image.

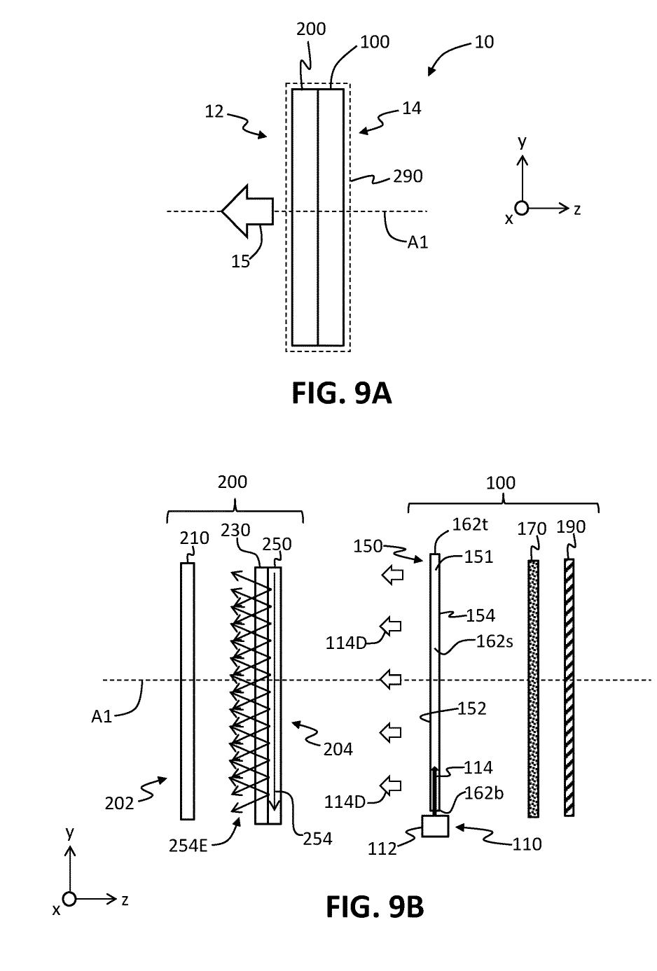

FIG. 9A is similar to FIG. 1 and illustrates an example embodiment of OLED luminaire 10 wherein illuminator 100 is adjacent the back side 204 of OLED structure 200 (i.e., is disposed behind the OLED structure). FIG. 9B is similar to FIG. 2 and shows more details of the components of the illuminator 100 and OLED structure 200. In this embodiment, illuminator 100 can additionally include a reflector layer 190 adjacent back side 154. In an example where light-redirecting member 150 includes light-redirecting layer 170, the light-redirecting layer is resides immediately adjacent backside 154 and thus resides between the reflector layer 190 and the light-redirecting member. This configuration acts to reflect light that travels in the +z direction and through the light-redirecting layer 170 so that it travels back in the −z direction. This enhances the overall amount of redirected light 114D that travels in the −z direction and into the OLED structure 200.

In an example, reflector layer 190 is a diffuse reflector, and in an example comprises a white scattering material (e.g., white paint or the like) that scatters light in the visible wavelength range in substantially equal amounts.

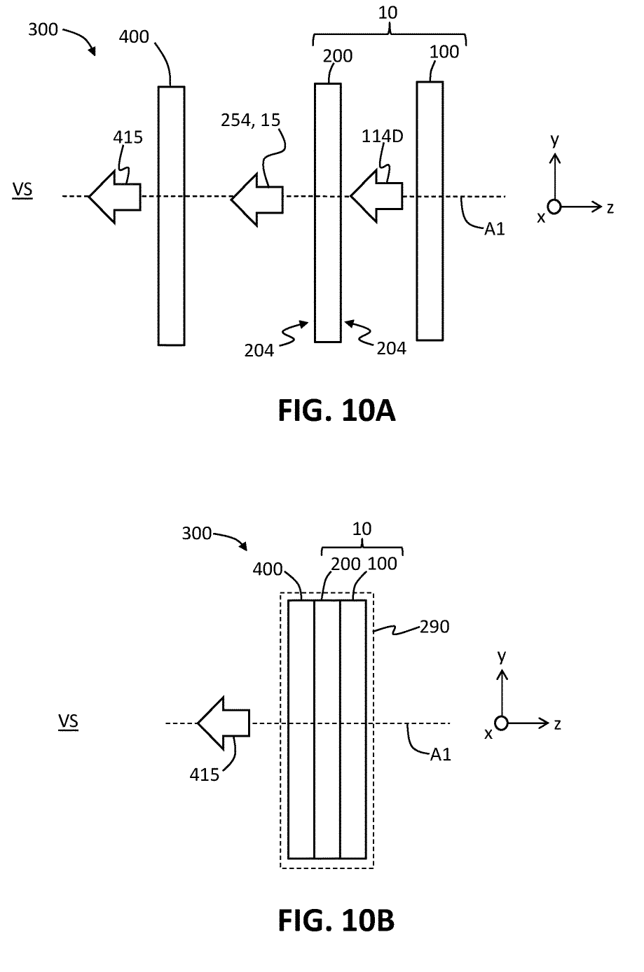

FIG. 10A is an exploded side view of an example LCD system 300 that includes the OLED luminaire 10 of FIGS. 9A and 9B operably arranged relative to an LCD panel 400. FIG. 10B is a non-exploded view of the LCD system 300 of FIG. 10A. As described above, illuminator 100 generates redirected light 114D that travels in the +x direction to OLED structure 200. In response, OLED structure generates emitted light 254 that also travels generally in the +x direction and that constitutes illumination 15. Note that in this configuration the emitted light 254 from OLED structure 200 does not pass through the light-redirecting member, which resides behind the OLED structure. The OLED illumination 15 serves to back illuminate LCD panel 400. As in the previously described embodiment, LCD panel 400 operates in the manner known in the art to modulate the OLED illumination 15 to generate a display light 415 that defines a display image.

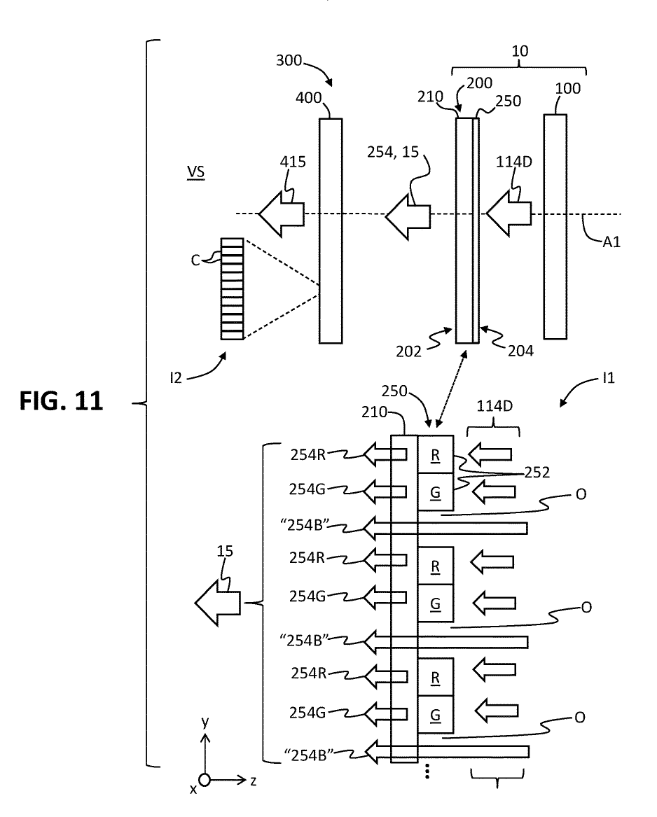

FIG. 11 is an exploded side view of an example embodiment of an LCD system 300 wherein the organic layer 250 includes discrete sections or segments 252 made of different organic materials that respectively emit light at one of two or more wavelengths, e.g., primary colors such as red R and green G, as shown by way of example in the close-up inset 11. Also in an example, organic layer 252 can include openings O where no organic material is present so that redirected light 114D can pass directly through the organic layer to serve as the third primary color. In an example, discrete sections 252 are formed (e.g., patterned) using known deposition techniques. In an example, the discrete sections 252 are formed as dots. Also in an example, discrete sections 252 are sized as sub-pixels and are grouped e.g., red R, green G and open O (which in this example passes blue B) to define multicolor pixels for the LCD system. Thus, the discrete sections 252 are also referred to below as “sub-pixels.” Note that the sub-pixels 252 need not be in contact with one another and in example are spaced apart from one another, and further in an example have a light-absorbing material in the spaces between the sub-pixels.

In an example, OLED structure 200 of FIG. 11 need not include the extraction layer 230, so that the organic layer 250 can reside directly on substrate 210. In such an example, the amount of emitted light 254 extracted from OLED structure 200 is traded off to have the light-emitting OLED layer segments 252 reside as close as possible to the LCD panel 400. Also shown in the close-up inset 12 of FIG. 11A is the discrete structure of the LCD panel 400, which includes an array of aforementioned light-controlling switches or cells C. The cells C are independently addressable liquid-crystal cells. The amount of light that can pass through each cell C is electrically controlled by arrays (grids) of transparent electrodes (i.e., anodes and cathodes), as is known in the art of LCDs.

With reference to close up inset 11 of FIG. 11, the redirected light 114D from illuminator 110 travels in the −z direction and is incident upon the organic layer 250 of OLED structure 200. Some of the redirected light is incident upon red R sub-pixels 252, which causes the red sub-pixel to emit red light 254R. Likewise, some of the redirected light is incident upon green G sub-pixels 252, which causes the green sub-pixel to emit green light 254G. Some of the redirected light 114D is incident upon openings O in organic layer 250 and thus passes directly through the OLED structured 200 as blue light, which is denoted in quotes as “254B” to indicate that this light is similar to OLED-emitted blue light. Note that in this example, blue light 254B is not actually emitted from the organic layer because there is no blue-emitting organic material needed since the redirected light is already blue. In an alternative example, the organic layer 250 can have a blue sub-pixel 252, in which case the blue light would be emitted blue light 254B. This might be the case, for example, when redirected light 114D has a color other than blue, e.g., violet or ultraviolet. In an example, the combination of red, blue and green light 254R, 254B (or “254B”) and 254G can be used to form illumination 15 over a color gamut, including white.

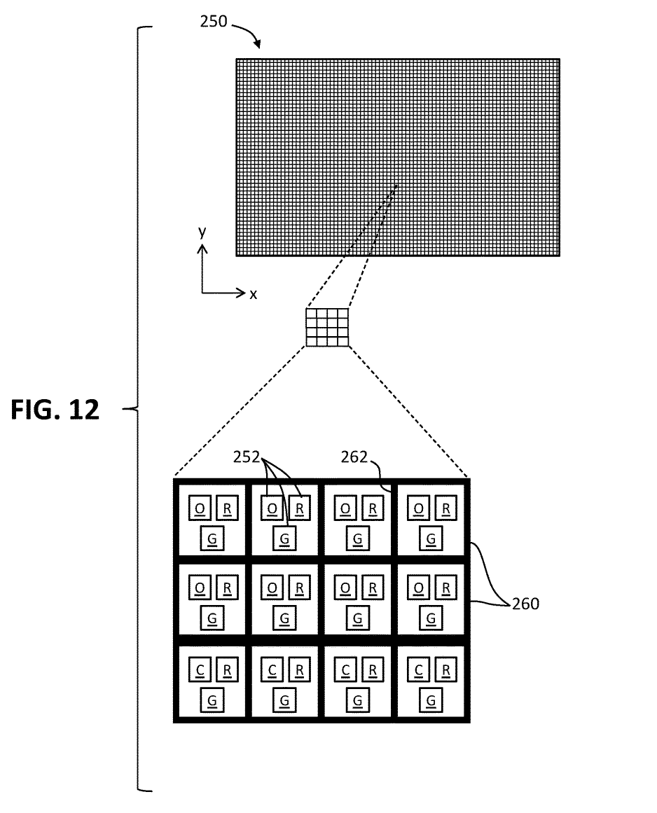

FIG. 12 is a front-on view of an example organic layer 250 wherein groups of R, G and O sub-pixels 252 define pixels 260. In an example, adjacent pixels are separated by an absorbing isolation region 262.

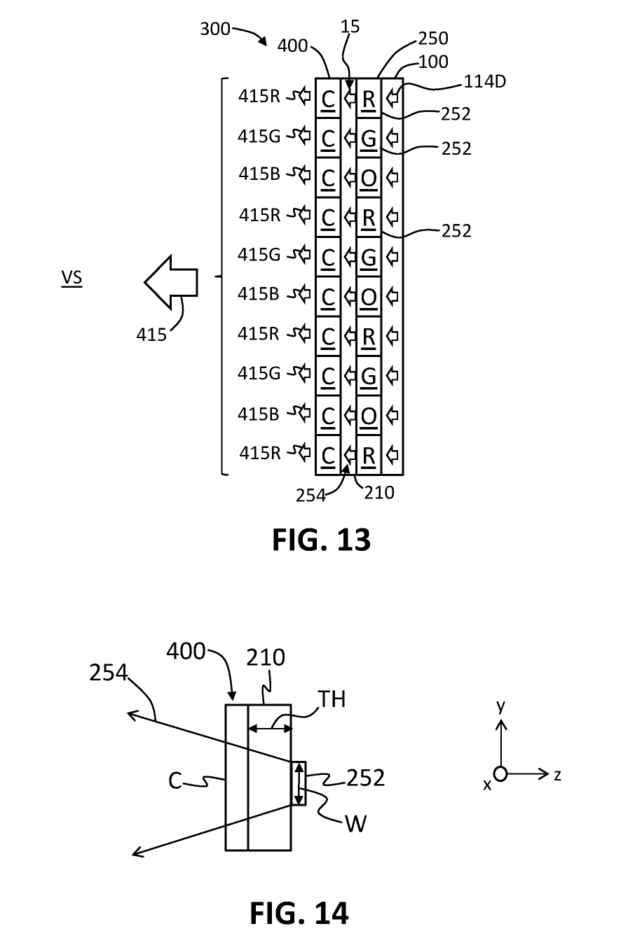

FIG. 13 is a cross-sectional view of the LCD system 300 of FIG. 11 that shows the sub-pixels 252 of organic layer 250 of OLED structure 200 aligned in the z-direction with corresponding cells C of LCD panel 300. In the operation of LCD system 300, redirected light 114D travels in the −z direction to OLED structure 200, which generates illumination 15 as described above. The illumination 15 includes red R, green G and blue B colors. Each of the sub-pixels 252 is aligned in the z-direction with a corresponding cell C. This allows for the light 15 associated with each sub-pixel 252 to be modulated by the corresponding (adjacent) cell C, so that the display light 415 can comprise different colors (e.g., 415R, 415G and 415B, as shown by way of example) to form a color display image over a color gamut. In other examples, other primary colors of light besides red, green and blue (or in addition thereto) can be used to define the color gamut (e.g., yellow, cyan and magenta). By utilizing segments 252 of organic material wherein the different segments each emits light of one of the primary colors, no color filters are required in the LCD system 300.

FIG. 14 is a close-up cross-sectional view of a portion of the LCD system of FIG. 11 that shows an example organic layer segment (sub-pixel) 252 in relation to its corresponding cell C of the LCD panel 400. Note that in the example, the glass substrate 210 resides between and thus separates the organic layer segment 232 and cell C. The light 254 from the organic layer segment 252 diverges. Thus, in an example the sub-pixels 252 are made smaller than the cells C of the LCD panel 400 to account for this light divergence, which occurs over the thickness TH of substrate 210. In an example, the sub-pixels have a width W about the same as the thickness TH of substrate 210, and in one example, W and TH are each about 200 microns.

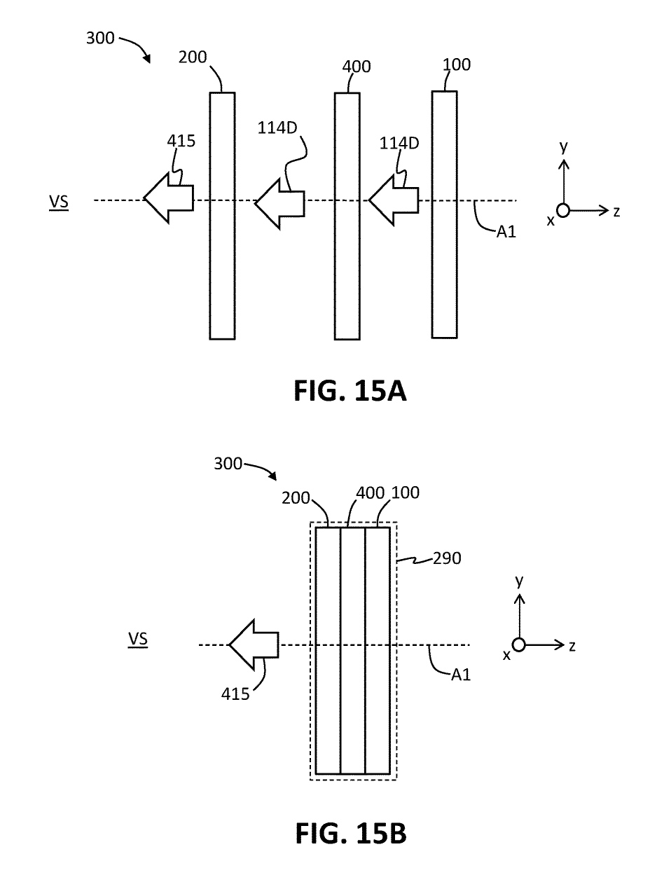

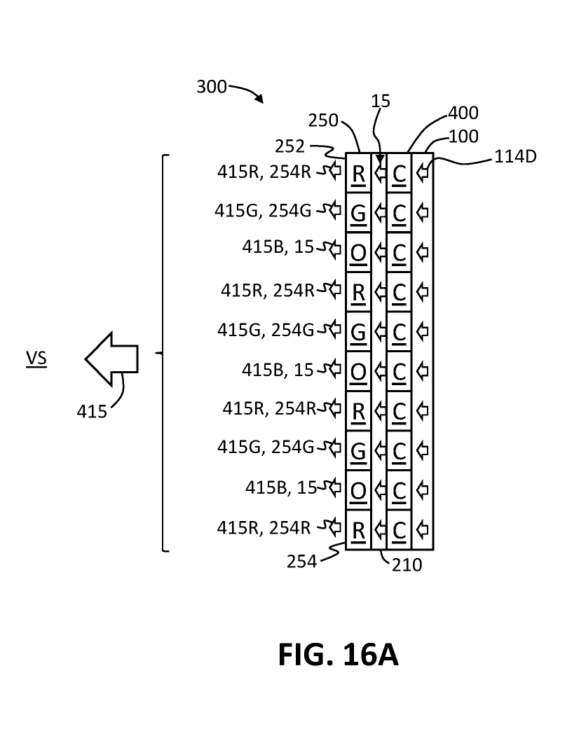

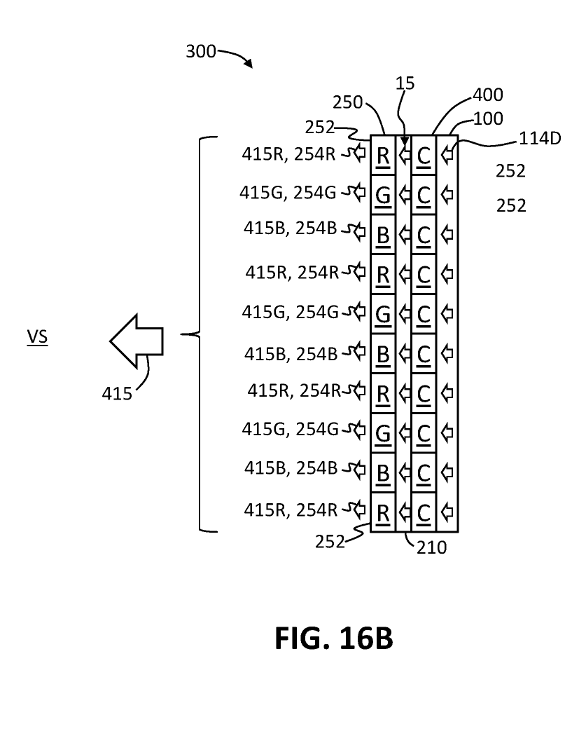

FIGS. 15A and 15B are similar to FIGS. 10A and 10B and illustrate an example LCD system 300 wherein the order of the LCD panel 400 and the OLED structure 200 are switched so that the OLED structure 200 is now closer to the viewer side VS. FIG. 16A is similar to FIG. 13 and shows a close-up side view of LCD system 300. In the operation of LCD system 300 of FIGS. 15A and 15B, the redirected light 114D from illuminator 100 is incident first upon LCD panel 400. The cells C of LCD panel 400 serve to locally control the intensity of the redirected light 114D that passes through to the OLED layer 250 of OLED structure 200. The OLED sections 252 are aligned with cells C so that a select amount (e.g., intensity) of redirected light 114D excites the corresponding OLED section. The OLED sections 252 emit light 254 in proportion to the amount of redirected light 114D provided. In the example shown, the OLED sections 252 are respectively configured to emit red light 254R and green light 254G, with the redirected light 114D being blue light “254B” that passes directly through the open portions O. The emitted (or emitted plus passed) light 254 defines display light 415, which is shown as being constituted by different colors (e.g., 415R, 415G and 415B) to form a color display image over a desired color gamut. In an example, cells C can be controlled in a binary fashion to be in either an on (transmit state) or an off (light-blocking) state. As discussed above, the OLED sections or sub-pixels 250 can be grouped into color pixels 260.

FIG. 16B is similar to FIG. 16A and shows an example wherein the OLED layer 250 includes blue-emitting sections 252B that emit blue light 254B. This configuration can be used when the redirected light 114D has a wavelength other than blue, such as violet or ultraviolet.

A typical LCD system is black (i.e., has a black screen or a black background as seen by a viewer) when in the off state. An aspect of the disclosure includes providing a non-black background for LCD system 300 when the system is in an “off” state. Here, the “off” state means that the LCD system is not being used to form a conventional display image. This state is also referred to as a “background” state. This non-black background feature can be accomplished in the background state by configuring cells C to transmit at least some illumination 15 as background illumination while keeping the illuminator 100 on. In an example, cells C can be set in the “open” or full transmission state while illuminator 100 is operated in a low-output state that generates a reduced amount of redirected light 114D as compared to a normal or high-output state used to generate a display image. In the example where the illumination can include the three primary colors, then the “off” state background color of the LCD system can be white or any other color within the color gamut. The background colors can also be modified to change with time, and can even be used to create background patterns akin to screen-saver images used on present-day computers. Also in an example, in the “off” or background state, there is no display light 415 and the LCD system 300 is substantially translucent (i.e., the “background” is substantially translucent) so that a viewer on the viewer side VS can see through the LCD system.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

1. A luminaire apparatus that emits illumination, comprising:
an illuminator having at least one light source that generates first light having a first wavelength, the light source being operably coupled to a light-redirecting member, which receives the first light and forms therefrom redirected light;
an organic light-emitting device (OLED) structure operably arranged adjacent the light-redirecting member, the OLED structure having at least one organic layer that emits light when irradiated by the redirected light, wherein the OLED structure does not include any conductive electrodes; and
optionally, a sealing structure operably disposed around at least the at least one organic layer;
wherein the emitted light from the OLED structure constitutes the illumination.

2. The luminaire apparatus according to claim 1, wherein the light-redirecting member includes a planar sheet that is substantially transparent to the first light and that includes at least one type of light-redirecting feature.

3. The luminaire apparatus according to claim 2, wherein the at least one type of light-redirecting feature is selected from the group of light-redirecting features comprising: a light-redirecting layer, a surface roughness, internal voids, internal particles and internal refractive index variations.

4. (canceled)

5. The luminaire apparatus according to claim 1, wherein the at least one organic layer includes multiple organic layers, with each organic layer emitting a different wavelength of light when irradiated by the redirected light.

6.-9. (canceled)

10. The luminaire apparatus according to claim 1, wherein OLED structure includes opposite front and back surfaces, wherein the light-directing member is operably arranged adjacent the front surface of the OLED structure, and wherein the illumination light travels through the front surface of the OLED structure and then through the light-redirecting member.

11. The luminaire apparatus according to claim 10, wherein the OLED structure includes a light-redirecting layer arranged adjacent the at least one organic layer on a side opposite the light-redirecting member so that the light-redirecting member and the light-redirecting layer sandwich the at least one organic layer.

12. The luminaire apparatus according to claim 11, wherein the at least one OLED layer generates light that remains trapped therewithin, and wherein the light-redirecting layer has a rough surface arranged in intimate contact with the at least one organic layer, the rough surface having an amount of surface roughness that facilitates the extraction of trapped light from the at least one organic layer, wherein the amount of surface roughness of the rough surface of the light-redirecting layer is greater than 50 nm root-mean-square and has a periodicity of less than 2 microns.

13. (canceled)

14. The luminaire apparatus according to claim 1, wherein OLED structure includes opposite front and back sides, wherein the light-directing member is operably arranged adjacent the back side of the OLED structure, and wherein the redirected light travels through the back side of the OLED structure and the illumination is emitted from the OLED structure through the front side of the OLED structure.

15. The luminaire apparatus of claim 14, further including a diffuse reflective layer on a side of the light-redirecting member opposite the OLED structure.

16. A display system, comprising:
the luminaire apparatus according to claim 1; and
a liquid-crystal display panel operably arranged adjacent the luminaire apparatus to receive the illumination from the luminaire;
wherein the display system is optionally encompassed by a sealing structure.

17. The display system according to claim 16, wherein the LCD panel includes an array of cells configured to control the transmission of light therethrough, and wherein the at least one organic layer includes a segmented organic layer having an array of segments, with each segment being aligned with a corresponding cell of the LCD panel and wherein, each segment optionally emits light having a primary-color wavelength.

18. (canceled)

19. The display system according to claim 16, wherein the redirected light is blue, wherein each segments emits one of red and green primary-color light, and wherein the segmented organic layer includes open portions that are aligned with corresponding cells of the LCD panel and that pass the blue redirected light.

20. The display system according to claim 16, wherein the display system has a viewer side, and wherein the LCD panel resides on the viewer-side of the segmented organic layer.

21. The display system according to claim 16, wherein the display system has a viewer side, and wherein the segmented organic layer resides on the viewer side of the LCD panel.

22. The display system according to claim 16, wherein the display system is encompassed by a sealing structure.

23. A method of forming illumination, comprising:
providing an organic light-emitting device (OLED) structure having front and back surfaces and at least one organic layer that emits light when irradiated with light of a first wavelength, wherein the OLED structure does not include any conductive electrodes; and
generating first light of the first wavelength and redirecting the first light to irradiate the at least one organic layer through either the front or back surface of the OLED structure to cause the at least one organic layer to emit light from the front surface of the OLED structure, wherein the emitted light constitutes the illumination.

24. The method according to claim 23, wherein redirecting the first light includes sending the first light through a light-redirecting member that includes at least one type of light-redirecting feature.

25.-26. (canceled)

27. The method according to claim 26, wherein the illumination includes red, green and blue light, and wherein the LCD panel is configured to transmit the display light over a color gamut defined by the red, green and blue illumination.

28.-29. (canceled)

30. The method according to claim 23, wherein the OLED layer includes segments, with each segment emitting light have one wavelength of two or three primary-color wavelengths when irradiated by the redirected light, and wherein the emitted light from each segment passes through at least one cell of an LCD panel arranged adjacent the OLED structure; and optionally, wherein each segment emits either red or green light, wherein the OLED layer includes openings through which the illumination light can pass through, and wherein the illumination is blue light.

31. (canceled)

32. The method according to claim 23, wherein the OLED layer includes segments, with each segment emitting light have one wavelength of two or three primary-color wavelengths when irradiated by the redirected light, and wherein the illumination, passes through at least one cell of an LCD panel and then irradiates at least one segment of the OLED layer; and optionally, wherein each segment emits either red or green light, wherein the OLED layer includes openings through which the illumination light can pass through, and wherein the illumination is blue light.

33. (canceled)
